(19) United States
(12) Patent Application Publication
(10) Pub. No.: US 2026/0199960 A1
(43) Pub. Date: Jul. 16, 2026

(54) Self-Pierce Riveting Tool And Method For Setting A Self-Piercing Type Rivet

(71) Applicant: Newfrey LLC, New Britain, CT (US)

(72) Inventors: Michael KAESLER, Giessen (DE); Sven Boensel, Giessen (DE); Joachim Moeser, Giessen (DE); Patrick Gruber, Giessen (DE)

(73) Assignee: Newfrey LLC, New Britain, CT (US)

(21) Appl. No.: 19/559,282

(22) Filed: Mar. 6, 2026

Related U.S. Application Data
(63) Continuation of application No. PCT/EP2024/074874, filed on Sep. 5, 2024.

(30) Foreign Application Priority Data
Sep. 8, 2023 (EP) 23196218.4
Sep. 8, 2023 (EP) 23196228.3

(51) Int. Cl. B21J 15/02; B21J 15/08; B21J 15/18; B21J 15/32; H05H 1/32

(52) U.S. Cl. CPC B21J 15/025; B21J 15/08; B21J 15/18; B21J 15/32; H05H 1/32

(57) ABSTRACT

A method for setting a self-piercing type rivet, a device for thermally assisting the riveting process of a self-pierce riveting tool, and a self-pierce riveting tool for setting a self-piercing type rivet are disclosed. The self-pierce riveting tool comprises a setting assembly with a mount in the form of a C-shaped frame having a first end and a second end, a punch disposed on the first end of the C-shaped frame, a clamping device mounted to the mount, a die disposed on the second end of the C-shaped frame and lying coaxially opposite the punch along a setting axis, and a drive unit that effects a relative movement of punch and die and which moves the punch relative to the mount. The self-pierce riveting tool further comprises a plasma torch mounted to the clamping device and connected to the mount through the clamping device.

### CROSS-REFERENCE TO RELATED APPLICATIONS

This application is a bypass continuation of International Application No. PCT/EP2024/074874, filed on September 5, 2024, which claims the benefit and priority of European Application No. 23196218.4, filed on September 8, 2023, and European Application No. 23196228.3, filed on September 8, 2023. The entire disclosure of each of the above applications is incorporated herein by reference.

### FIELD

The present disclosure relates to a self-pierce riveting tool used to perform a thermally assisted joining and adapted to join a workpiece arrangement (for instance two sheets or components or workpieces arranged one above the other) with a self-piercing type rivet. The present disclosure also relates to a method used to perform a thermally assisted joining for setting a self-piercing type rivet.

### BACKGROUND

In the automotive industry, the demand for lightweight yet robust vehicles has led to the widespread adoption of high-strength materials such as advanced high-strength steels (AHSS), aluminum alloys, and composite materials. These materials offer superior mechanical properties but present significant challenges in terms of joining techniques. Traditional joining methods, such as welding and bolting, often prove inadequate due to issues like thermal distortion, material incompatibility, and the need for additional surface treatments.

Self-pierce riveting (SPR) has emerged as a preferred method for joining high-strength materials, as it does not require predrilled holes and minimizes thermal effects. SPR involves driving a rivet through the top layer of material and flaring it into the bottom layer, creating a strong mechanical interlock. However, the increased hardness and strength of modern materials necessitate advancements in SPR tool design to ensure reliable and efficient joint formation.

EP3515632 discloses for instance a method for joining at least one component to a second component without a preformed hole comprising a step of heat-treating a joining area before setting a fastener.

DE112007001331 for instance discloses a self-piercing riveting process comprising the step of enhancing the formability of at least a portion of at least one of the elements using a laser.

However, there is still a need to improve existing self-pierce riveting tools and methods for setting a self-piercing type rivet which are reliable, easily used and modular.

### SUMMARY

An object of the present disclosure is therefore to provide a self-pierce riveting tool, which is modular, compact and adapted to join a plurality of different materials, and a joining method by means of which the joining process is reliable and the cracks during the setting of the rivet are avoided.

Accordingly, the present disclosure provides a self-pierce riveting tool for setting a self-piercing type rivet comprising a setting assembly with:

a mount in the form of a C-shaped frame having a first end and a second end;

a punch disposed on the first end of the C-shaped frame;

a clamping device mounted to the mount;

a die disposed on the second end of the C-shaped frame and lying coaxially opposite the punch along a setting axis; and

a drive unit that effects a relative movement of punch and die and which moves the punch relative to the mount,

wherein the self-pierce riveting tool further comprises a plasma torch mounted to the clamping device and connected to the mount through the clamping device.

Mounting a plasma torch on the clamping device allows adjusting the distance between a component and the plasma torch, notably during the joining process. The self-pierce riveting tool, with a plasma torch mounted on the clamping device, allows downsizing the self-pierce riveting tool. Such self-pierce riveting tool can be used to join several different materials and workpieces, and notably brittle cast materials.

In an embodiment, a linear drive unit is connected to the clamping device and the mount for moving the clamping device in a linear direction relative to the mount. This increases the compacity of the device. The linear drive unit is for example a pneumatic piston or an electrical drive unit. In another embodiment, the linear drive unit may be a hydraulic drive unit.

In an embodiment, the self-pierce riveting tool further comprises a mounting body connected to the first or the second end of the C-shaped frame. The clamping device is movably connected to the mounting body.

In an embodiment, the mounting body comprises a cylinder holder, and the piston of a pneumatic drive is arranged within the cylinder holder.

In an embodiment, the mounting body is provided with a driving mechanism coupled with the linear drive unit for moving the clamping device in a linear direction. For instance, the driving mechanism comprises at least one linear ball bearing and guiding rods.

In an embodiment, the mounting body is removably connected to the mount. Thus, the self-pierce riveting tool can easily be adapted, is easier to maintain and repair and is versatile.

In an embodiment, the mounting body is screwed to the first end of the C-shaped frame. Screws provide a secure and reliable method of fastening components together. They create a strong and stable connection, ensuring that the mounting body remains securely attached during use.

In an embodiment, the clamping device is a one-piece clamping device connected to the mounting body with the driving mechanism. This enhances structural integrity.

In an embodiment, the distance between the setting axis and the point on the mounting body farthest from the setting axis is less than 200 millimeters (mm), preferably less than 180 mm. The self-pierce riveting tool is compact.

In an embodiment, the plasma torch is movably mounted in translation and/or rotation to the clamping device. The plasma jet can be easily adjusted to the joining area.

In an embodiment, the self-pierce riveting tool further comprises a rivet feeder with a receiver for automatically feeding self-piercing type rivets to the setting assembly, wherein the receiver is arranged opposite the plasma torch with regard to the mount. The position of the plasma torch does not interfere with the guiding of the rivet within the tool. In another variant, a pivoting arrangement between the receiver and the plasma torch may be implemented.

In an embodiment, the plasma torch substantially extends longitudinally along a plasma axis, the plasma axis forming an angle between 5 and 80 degrees, preferably between 25 and 60 degrees with the setting axis in a cross-section. Even more preferably, the angle is between 30 and 50 degrees.

In an embodiment, the plasma torch and the clamping device are movable along the setting axis or a direction parallel to the setting axis and along a direction orthogonal to the setting axis. This allows the self-pierce riveting tool to be used in different configurations. Notably, when the use of the plasma torch is not necessary for a particular joining and the accessibility is reduced, the clamping device and plasma torch may be shifted to the side, such that the accessibility around the die and the punch is increased (and not limited by the clamping device and the plasma torch anymore). Such a tool is thus easily adapted to different configurations.

The present disclosure is also directed to a device for thermally assisting the riveting process of a self-pierce riveting tool, the device comprising:

a mounting body adapted to be removably fixed to the mount of a self-pierce riveting tool;

a clamping device connected to the mounting body; and

a plasma torch.

The device can easily be attached to the mount of a self-pierce riveting tool and be removed when necessary. Thus, the device with the mounting body, the clamping device and the plasma torch forms an add-on module which can be detached from the mount depending on the joining process used.

Finally, the present disclosure is directed to a method for setting a self-piercing type rivet, the method comprising the steps of:

providing at least one component;

providing a self-pierce riveting tool as mentioned above;

holding the at least one workpiece against the die with the clamping device,

preheating the at least one component in an area of a joining location of the at least one component to a temperature in the range from 90 degrees Celsius (°C) to 1,400 °C with the plasma torch; and

driving the self-piercing type rivet with the punch into the at least one component in the joining location.

### BRIEF DESCRIPTION OF THE DRAWINGS

The teachings of the present disclosure and their advantages will be better understood from the reading of the following description, given by way of example only and with reference to the accompanying drawings, of which:

FIG. 1A shows a perspective view of the self-pierce riveting tool in an initial position according to a first embodiment of the present disclosure with a mount, a die, a punch, a clamping device and a plasma torch, wherein the clamping device main axis is aligned with the joining axis of the self-pierce riveting tool;

FIG. 1B shows a perspective view of the self-pierce riveting tool in an initial position according to a second embodiment of the present disclosure with a mount, a die, a punch, a clamping device and a plasma torch, wherein the clamping device main axis is offset with regard to the joining axis of the self-pierce riveting tool;

FIG. 2A shows a front view of the self-pierce riveting tool of FIG. 1A in an initial state;

FIG. 2B shows in detail the position of the plasma torch of FIG. 2A;

FIG. 3A shows a front view of the self-pierce riveting tool of FIG. 1B in an initial state;

FIG. 3B shows in detail the position of the plasma torch of FIG. 3A;

FIG. 4A shows the self-pierce riveting tool of FIG. 1A or FIG. 1B with the plasma torch being in a used position;

FIG. 4B shows in detail the position of the plasma torch of FIG. 4A;

FIG. 5A shows the self-pierce riveting tool of FIG. 1A or FIG. 1B in a riveting position;

FIG. 5B shows in detail the position of the plasma torch of FIG. 5A; and

FIG. 6 shows a perspective top view of the self-pierce riveting tool of FIG. 1A.

### DETAILED DESCRIPTION

The embodiments of the disclosure will be best understood by reference to the drawings, wherein the same reference signs designate identical or similar elements. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure.

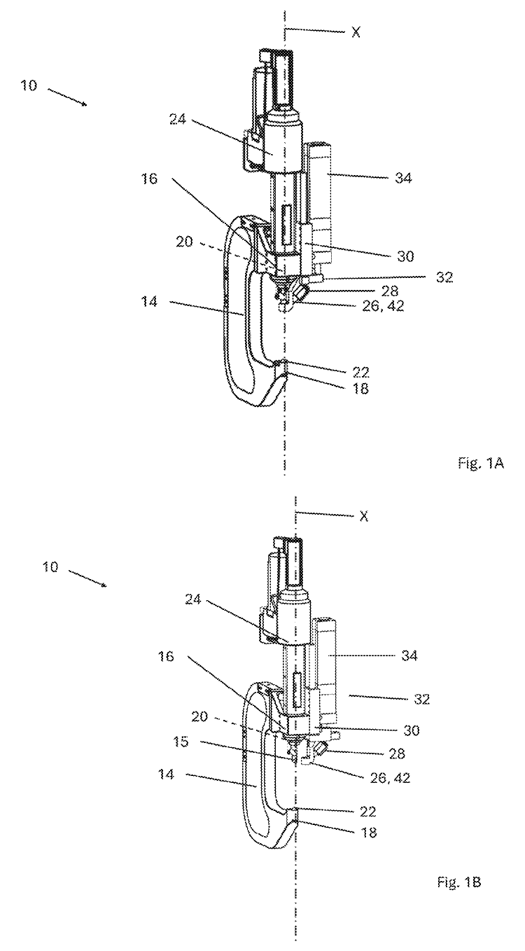

FIG. 1A and FIG. 1B show a perspective view of a self-pierce riveting tool 10 according to a first and a second embodiment. The self-pierce riveting tool 10 is adapted to carry out a method for joining a workpiece arrangement W comprising at least one workpiece or component, preferably at least two workpieces or components or sheets arranged above one other, together with a self-piercing type rivet. The self-pierce riveting tool 10 can be moved freely in space by means of a robot (not represented). Eventually, as an alternative, the self-pierce riveting tool 10 can be fixed to a structure and the workpieces to be joined moved toward self-pierce riveting tool 10 when needed.

The self-pierce riveting tool 10 comprises a setting assembly with a mount 14. The mount 14 is in the form of a C-shaped frame. The C-shaped frame may be mounted on a front end of an arm of the robot. The C-shaped frame has a first end 16 and a second end 18. A punch 20 is located on the first end 16 side of the C-shaped frame. In a known manner, the punch 20 is connected to a spindle of the tool 10. A die 22 is mounted at the second end 18 of the C-shaped frame. For instance, the punch 20 is mounted to an upper end of the C-shaped frame, and the die 22 is mounted to a lower end of the C-shaped frame. The punch 20 is arranged coaxially opposite the die 22 along a joining or setting axis X. The punch 20 opposes the die 22 so as to be capable of moving toward/away from the die 22. The C-shaped frame is advantageously formed so as to pinch the components to be riveted at a riveting site thereof between the punch 20 and the die 22, each being located in an upper or a lower side, respectively, of the mount 14. The upper and lower sides correspond to the first and second ends 16 and 18, respectively, for instance. A drive unit 24 effects a relative movement of punch 20 and die 22. For instance, the drive unit 24 moves the punch 20 relative to the mount 14. In a known manner, a receiver 15 that receives the rivet before or during the riveting process is located on the first end 16 side of the C-shaped frame. In a known manner, the receiver 15 is connected to the spindle of the tool. The receiver 15 comprises a front end configured to ensure that the workpiece is held firmly in place during the riveting process. This prevents any movement or shifting that could affect the accuracy and quality of the riveting operation

A clamping device 26 is arranged on the mount. With the clamping device 26 (whose force is adjustable), it can be determined how tightly the sheets are pressed together and, therefore, how strong the heat transfer between the sheets is (as described below). A plasma torch 28 is arranged on the clamping device 26. In other words, the plasma torch 28 is indirectly connected to the mount 14 through the clamping device 26.

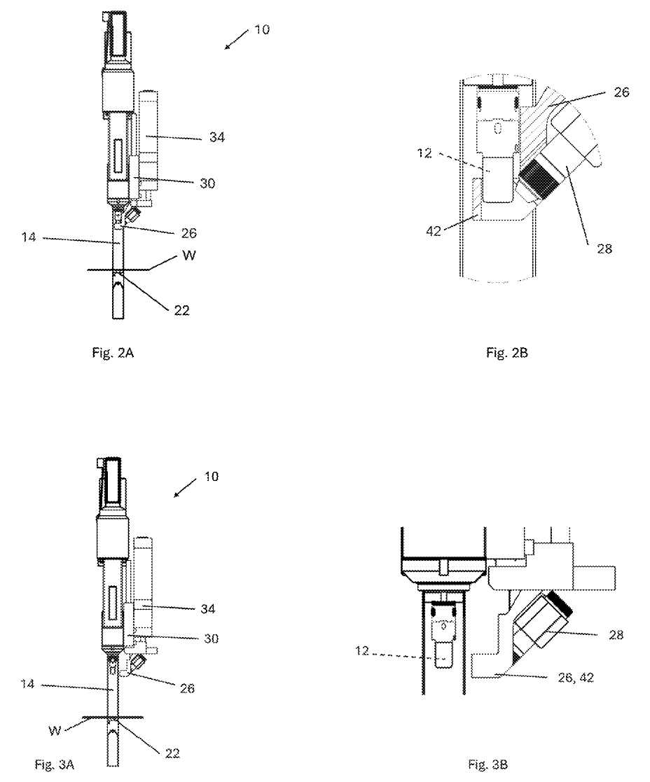

A mounting body 30 is arranged on the mount 14. The mounting body 30 is arranged on the first end 16 of the C-shaped frame. The mounting body 30 is removably fixed to the mount 14. For instance, the mounting body 30 is screwed to the mount (and more particularly to the first end 16 of the mount 14). The mounting body 30 comprises a recess adapted to form a holder 32. More particularly, the recess is adapted to receive a linear drive unit 34 connected to the clamping device 26 for moving the clamping device 26 in a linear direction. The mounting body 30 may be a one-part element or a two-part (or more) element. The mounting body 30 is for instance provided with a driving mechanism coupled with the linear drive unit 34 for moving the clamping device 26 in a linear direction. The driving mechanism may comprise one or more linear bearing 38. The driving mechanism may comprise one or more guiding rods 40. The linear drive unit 34 may be a pneumatic piston. In another embodiment, an electric or a hydraulic actuator may also be used. The clamping device 26 is movable along an axis parallel or substantially parallel to the joining axis X. The clamping device 26 may also be movable such as to be offset from the joining axis X, for instance in an initial position, as depicted in FIG. 1B and FIG. 3A and FIG. 3B. More particularly, in a first embodiment, the clamping device 26 is aligned with the joining axis X and may not be offset from the joining axis X, as depicted for instance in FIG. 1A, FIG. 2A and FIG. 2B. In the second embodiment, the clamping device 26 is movable such as to be offset from the joining or setting axis X (see FIG. 1B and FIG. 3A and FIG. 3B). More particularly, the offset position of the clamping device 26 with the plasma torch 28, allows a bigger accessibility. If the joining process does not require the use of the plasma torch 28, the plasma torch 28 and the clamping device 26 may remain offset with regard to the setting axis X and a joining requiring a biggest accessibility for the workpiece arrangement may be realized.

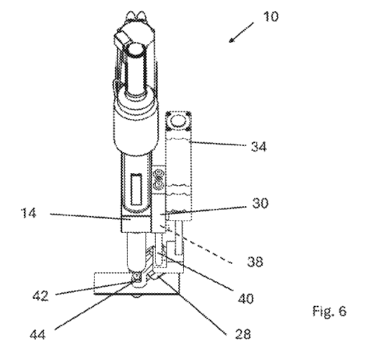

The clamping device 26, moved by the linear drive unit 34 through the driving mechanism, comprises a clamping body 42. The clamping body 42 defines a recess or a clearance 44 (FIG. 6). The clamping body 42 may be preloaded and the preload force can be adjusted through different springs or adjustable compression of the spring. The punch 20 can pass through the clearance 44 provided by the clamping device 26, and drives the self-piercing type rivet 12 through the component(s). For instance, the clamping body 42 is integral. It comprises a first section S1 connected to the driving mechanism and a second section S2 adapted to hold the workpiece or component firmly in place to ensure the components to be joined are properly aligned and do not move during the riveting process. The second section S2 comprises the recess or clearance 44 (as better seen on FIG. 6) and the edges of the clearance 44 are adapted to contact the workpiece. The clamping device 26 may comprise a load measurement system or an integrated load cell adapted to directly measure the clamping force applied by the clamping device to the workpiece arrangement W. The load measurement system will measure the clamping force and send it to a control unit to monitor and/or control the correct implementation of the setting steps (better described below). A temperature measurement device may also be provided. For instance, a temperature sensor with or without contact may be arranged on the clamping device 26. The temperature sensor is adapted to measure the temperature on the surface of the workpiece to be joined. More particularly, the temperature sensor is adapted to measure the temperature on the joining area.

The clamping device 26 may comprise a surface detection unit adapted to detect an upper surface of the workpiece arrangement W. The surface detection unit may comprise a laser adapted to measure, without contact, the distance from the workpiece, or a capacitive sensor or an inductive sensor or any other contactless proximity sensor. Alternatively, the surface detection unit may comprise a device for a mechanical or touch measurement for tactile surface recognition. The surface detection may be realized with or without an additional component.

The clamping device 26 may comprise a load measurement system or an integrated load cell adapted to directly measure the clamping force F applied by the clamping device to the workpiece arrangement W. The load measurement system will measure the clamping force and send it to a control unit to monitor and/or control the correct implementation of the setting steps (better described below).

The plasma torch 28 is a device used to generate and direct a plasma jet. More particularly, the plasma torch delivers an atmospheric pressure plasma Jet. It is a non-thermal plasma jet, also known as a non-transferred arc plasma jet. The non-thermal plasma jet operates at typically in the range of 30 to 700 degrees Celsius (°C). The plasma torch 28 operates by ionizing a gas to create plasma, which is then expelled through a nozzle. The plasma torch is arranged on the clamping device 26 to thermally assist the riveting during the setting process. The plasma torch 28 may be fixedly (or immovably) fixed to the clamping device 26 or may be movably fixed to the clamping device 26. For instance, the plasma torch 28 may rotate with regard to the clamping device 26 such that the plasma jet angle may be adjust. In another embodiment, the plasma torch 28 may translate with regard to the clamping device 26 such that the distance between the plasma torch 28 and the component can be adjusted. In another embodiment (not represented), the plasma torch 28 may be movable through a slider with separate stroke and force cylinder. A linear guide or rail may be provided such that the plasma torch 28 is moved with a drive mechanism, such as a motor or actuator, that generates the necessary force to move the carriage along the guide. This allows for smooth and accurate linear motion of the plasma torch 28. Such carriage may be used for instance to allow a motion of the clamping device 26 not only along the joining direction, but also away from the joining axis X. A lever mechanism with the linear drive unit 34 can also be used.

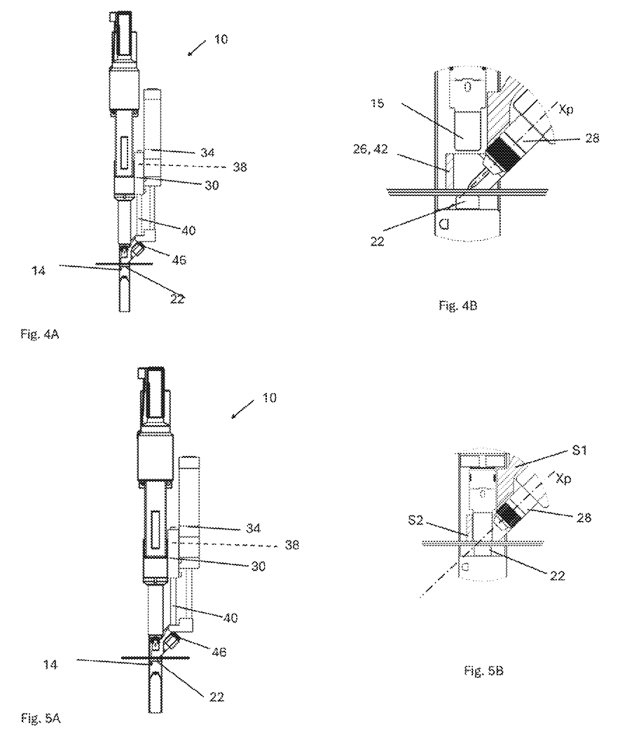

The plasma torch 28 is arranged at a non-zero distance from the clearance. For instance, the clamping device 26 comprises a recess or a portion 46 (FIGS. 4A and 5A) adapted to receive or connect plasma torch 26. For example, the plasma torch 28 substantially extends longitudinally along a plasma axis Xp. The plasma axis Xp may form an angle between 5 and 80 degrees with the setting axis X in a cross-section, and more particularly an angle between 30 and 60 degrees. For instance, an angle of 35 degrees or 45 degrees may be used.

The mounting body 30, the clamping device 26, the plasma torch 28, the linear drive unit 34 and the driving mechanism form a device or a unit which ban be fixed to or removed from the mount 14. For instance, screws are used to fix the device to the mount 14 (through the mounting body 30). The device forms an independent unit for thermally assisting the riveting process of a self-pierce riveting tool and can be fixed to a self-pierce riveting tool already known from the state of the art.

FIGS. 2A, 2B, FIGS. 3A, 3B, FIGS. 4A, 4B and FIGS. 5A, 5B shows the self-pierce riveting tool 10 at different steps of the setting process.

In a first step, as depicted on FIG. 2A (first embodiment) or FIG. 3A (second embodiment), the self-pierce riveting tool 10 is in an initial position. The workpiece arrangement W is arranged on the die 22. The workpiece arrangement W comprises at least one component. For instance, the workpiece arrangement comprises two sheets without a preformed (for example, a predrilled or pre-punched) hole. The punch 20 and the clamping device 26 are both in a first position, which is a rest position, at a non-zero distance from the die 22 and the workpiece arrangement W. As visible in FIG. 2B the plasma torch 28, fixed to the clamping device 26, is off.

In the first embodiment, the clamping device 26 is aligned with the joining axis X.

In the second embodiment, depicted in FIG. 3A, the clamping device 26 is offset from the joining axis X. In order for the plasma torch 28 and the clamping device 26 to be used, a driving mechanism moves the clamping device 26 and the plasma torch 28 from the offset position to the aligned position.

In a second step, shown in FIG. 4A, the clamping device 26 with the plasma torch 28 is moved toward the workpiece arrangement W, until the clamping device 26 contacts the workpiece arrangement W and the plasma torch 28 is at a predetermined distance from the workpiece arrangement W. As better seen in FIG. 4B, the plasma torch 28 points toward the die 22 such that the plasma jet coming out of the plasma torch 28 (when the plasma torch 28 is switched on), points to a designated joining area. More particularly, the plasma jet points at the die 22 in order to preheat the joining area where the self-piercing type rivet 12 will be set. With the clamping device 26 (whose force is adjustable), it can be determined how tightly the sheets are pressed together and, therefore, how strong the heat transfer between the sheets is (as described below). For instance, the plasma torch 28 may be arranged slightly below the receiver 15 (as depicted in FIG. 4A and FIG. 4B). The receiver 15 is positioned slightly above the plasma torch 28, otherwise the nozzle of the receiver 15 would burn when the plasma torch is used. For instance a distance between 5 and 45 mm may be kept. The plasma torch 28 is then switched on such that the joining area (corresponding to the area where the rivet is destined to be set) is heat-treated in such a way that a heat-affected zone is formed on the joining area and in that a first component of the workpiece arrangement W is heated in such a way that a strength of the first component in the heat-affected zone is reduced. Patent publication EP3515632A1 from the applicant explains for instance how the plasma torch assists the joining process.

As shown in FIG. 5A, once the strength of the joining area is reduced, the punch 20 drives the self-piercing type rivet 12 downward passing through the clearance provided by the clamping device 26, and drives the rivet 12 through the top layer of the workpiece arrangement W. As the punch 20 continues its downward motion, the rivet 12 pierces the top layer and flares out in the bottom layer of the workpiece arrangement W, creating a mechanical interlock. It is to be noted that the setting force may also be reduced by the thermal device, as described in more details in EP3515632A1. FIG. 5B shows in more details the position of the plasma torch 28. For the sake of clarity, the working arrangement is not visible on FIG. 5A and FIG. 5B.

After the rivet 12 is set, the punch 20 retracts, and the clamping device 26 releases the workpiece arrangement W, completing the riveting cycle.

For instance, the self-pierce riveting tool 10 may be used with a self-piercing type rivet 12 as disclosed in application number EP 23192697.3. However, other self-piercing type rivets may also be used.

self-pierce riveting tool 10

a workpiece arrangement W

self-piercing type rivet 12

mount 14

first end 16

second end 18

punch 20

die 22

setting axis X

drive unit 24

clamping device 26

plasma torch 28

mounting body 30

cylinder holder 32

linear drive unit 34

linear bearing 38

guiding rods 40

clamping body 42

clearance 44

first section S1

second section S2

recess or a portion 46

1. A self-pierce riveting tool for setting a self-piercing type rivet, the self-pierce riveting tool comprising a setting assembly with:
a mount in the form of a C-shaped frame having a first end and a second end;
a punch located at the first end of the C-shaped frame;
a clamping device mounted to the mount;
a die disposed on the second end of the C-shaped frame and lying coaxially opposite the punch along a setting axis; and
a drive unit that effects a relative movement of the punch and the die and which moves the punch relative to the mount,
wherein the self-piercing rivet tool further comprises a plasma torch mounted to the clamping device and connected to the mount through the clamping device.

2. The self-pierce riveting tool according to claim 1, wherein a linear drive unit is connected to the clamping device and the mount for moving the clamping device in a linear direction relative to the mount.

3. The self-pierce riveting tool according to claim 2, wherein the linear drive unit is an electrical drive unit or a pneumatical drive unit.

4. The self-pierce riveting tool according to claim 1, further comprising a mounting body connected to the first or the second end of the C-shaped frame, wherein the clamping device is movably connected to the mounting body.

5. The self-pierce riveting tool according to claim 4, wherein the mounting body is removably connected to the mount.

6. The self-pierce riveting tool according to claim 4, wherein the mounting body is screwed to the first end of the C-shaped frame.

7. The self-pierce riveting tool according to claim 4, wherein the clamping device is a one-piece clamping device connected to the mounting body with a driving mechanism.

8. The self-pierce riveting tool according to claim 4, wherein the distance between the setting axis and the point on the mounting body farthest from the setting axis is less than 200 mm, preferably less than 180 mm.

9. The self-pierce riveting tool according to claim 1, wherein the plasma torch is movably mounted in translation and/or rotation to the clamping device.

10. The self-pierce riveting tool according to claim 1, further comprising a rivet feeder with a receiver for automatically feeding self-piercing type rivets to the setting assembly, wherein the receiver is arranged opposite the plasma torch with regard to the mount.

11. The self-pierce riveting tool according to claim 1, wherein the plasma torch substantially extends longitudinally along a plasma axis, the plasma axis forming an angle between 5 and 80 degrees, preferably between 25 and 60 degrees with the setting axis in a cross-section.

12. The self-pierce riveting tool according to claim 1, wherein the plasma torch and the clamping device are movable along the setting axis or a direction parallel to the setting axis and along a direction orthogonal to the setting axis.

13. A device for thermally assisting the riveting process of a self-pierce riveting tool, the device comprising:
a mounting body adapted to be removably fixed to a mount of the self-pierce riveting tool;
a clamping device connected to the mounting body; and
a plasma torch.

14. A method for setting a self-piercing type rivet, the method comprising:
providing a workpiece arrangement with at least one component;
providing a self-pierce riveting tool;
holding the at least one component against a die with a clamping device of the self-pierce riveting tool;
preheating, with a plasma torch of the self-pierce riveting tool, the at least one component in an area of a joining location of the at least one component to a temperature in the range from 90 °C to 1,400 °C; and
driving the self-piercing type rivet with a punch of the self-pierce riveting tool into the at least one component in the joining location.
